(19) United States
(12) Patent Application Publication
(10) Pub. No.: US 2009/0015349 A1
(43) Pub. Date: Jan. 15, 2009

(54) METHOD AND APPARTUS FOR ALTERING PHASE SHIFT ALONG A TRANSMISSION LINE SECTION

(76) Inventor: Thomas J. Ellis, Dallas, TX (US)

Correspondence Address: CARR LLP, 670 FOUNDERS SQUARE, 900 JACKSON STREET, DALLAS, TX, 75202, US

(21) Appl. No.: 12/172,031

(22) Filed: Jul. 11, 2008

Related U.S. Application Data
(60) Provisional application No. 60/949,446, filed on Jul. 12, 2007.

(51) Int. Cl. H01P 1/18

(52) U.S. Cl. 333/161; 333/164

(57) ABSTRACT

A new technique is presented that allows for controlling the phase of a propagating signal by selectively switching in and out relatively small perturbations along a transmission line section that provide slightly different physical paths for the currents to follow. By using relatively minor perturbations, the phase of a transmission line section can be controlled without drastically altering the impedance of the section, thereby maintaining good impedance matching properties. Also, by keeping the alternate current paths small, generally fine control of phase shift is possible along with allowing the design to remain relatively simple. Such tunable elements can then be incorporated in designs where resonators (or other elements) are separated by specific phase lengths to construct other signal processing functions, such as filters.

### CROSS-REFERENCED APPLICATIONS

This application claims priority from U.S. Patent Application No. 60/949,446, entitled METHOD AND APPARATUS FOR ALTERING PHASE SHIFT ALONG A TRANSMISSION LINE SECTION, filed on Jul. 12, 2007.

### BACKGROUND OF THE INVENTION

1. Field of the Invention

The present invention relates generally to transmission lines and, more specifically, to tunable transmission lines.

2. Description of the Related Art

Most modern radar and communication systems rely on phase shifting elements as signal processing components, often in systems that combine multiple radiating signals of varying amplitudes and phases to control the directionality of radiated signals (i.e. phased-array systems). As these elements are often one of the last in a signal's transmit chain, their relative losses contribute significantly to the overall system performance (and limitations). In addition to loss, since any signals reflected due to mismatch will re-enter other components in the signal chain and potentially cause unwanted effects, their ability to stay “matched” while controlling their relative phase is very important.

There are many well known techniques for developing phase-shifting components for radio frequency (RF) systems; most introductory textbooks in the field include the basic concepts for such structures. The most common techniques can be broken down into three primary categories; reflective, loaded-line and switched-line phase shifters.

In reflective-type phase shifters (see for example, FIG. 1), the incoming signal is guided to a strongly reflective circuit element, often a variable capacitance, whose relative phase angle is related to the impedance of the element (as normalized to the impedance of the connecting transmission line). If the relative impedance can be controlled, the reflected signal will then have a phase angle directly related to the varied impedance of the circuit element. This element is often a varactor or other variable capacitance. In most cases the incoming and outgoing signals are separated from each other through the use of a 90° hybrid element, although a 3-port circulating device is also sometimes used. Drawbacks of this approach are that multiple components are needed (hybrids, varactors, RF chokes, etc) which all introduce loss along the signal path.

In “loaded-line” type phase shifters, the distributed capacitance (or inductance) of a section of line is designed to be adjustable. Since the velocity of the signal traveling along the line obeys the relationship

v=1/\sqrt{L′C′}

As the capacitance (or inductance) per unit length is varied, the signal will speed up or slow down accordingly. Such phase shifting elements are referred to as true time-delay phase shifters. Since the impedance (and therefore the reflections) of a transmission line section vary with the same parameters as velocity, it can be difficult to maintain good impedance properties while achieving large phase shifts.

Now, in switched-line phase shifters, multiple transmission-line paths are arranged in parallel from the input to the output of the circuit. Switching components are then added to the circuit to control which physical path the signal travels along. As such, different paths can be designed to provide whatever fixed phase lengths are desired. While good impedance matching can be achieved, one drawback of this technique is that large circuit areas are required for laying out the multiple transmission paths, which can be prohibitively expensive on many integrated circuit processes.

### SUMMARY OF THE INVENTION

A technique is disclosed that can allow for a tunable phase delay that has relatively low loss, is simple to design and control, is compact, and is easy to incorporate with various transmission line topologies. The technique allows for variable phase shifts by switching in and out small perturbations distributed along a transmission line element. By making the perturbations along the signal path generally small, the effective phase shift of a transmission line section can be achieved while reflections due to any impedance mismatch can be kept relatively small.

In some embodiments, small slots may be placed orthogonally along the transverse direction of a slot-type transmission line section to form a corrugated structure. The currents travel generally along the edges of the conductors and therefore follow the corrugations in the metal. In some embodiments, capacitive switches are placed in shunt with these “corrugations” such that when the switches are turned “on” they short circuit the particular corrugation they are placed across, allowing substantially all of the current to bypass that particular groove, thereby altering the phase delay of the signal. This process can be repeated on a “per unit length” basis so that varying amounts of total phase change can be achieved.

Small perturbations along a transmission line or waveguide section may provide an effective signal path that can be controlled by selectively switching in and out the perturbations to vary the phase length of that path. In this manner, the input-to-output phase delay can be controlled. The impedance of the transmission line section may also be varied in the same manner, in order to control the magnitude of a signal (from input to output), in addition to or instead of controlling the phase of a signal.

### BRIEF DESCRIPTION OF THE DRAWINGS

For a more complete understanding of the present invention and the advantages thereof, reference is now made to the following Detailed Description taken in conjunction with the accompanying drawings, in which:

FIG. 1 illustrates a schematic representation of a prior-art reflective phase shifter;

FIG. 2 provides a schematic representation of a prior art slot-type transmission line showing the current flow;

FIG. 3 provides a schematic representation of a corrugated slot-type transmission line showing how the current flow changes to conform to the slots;

FIG. 4 provides a schematic representation of a corrugated slot-type transmission line showing how the current flow changes when an individual slot is “shorted out”;

FIG. 5 provides a graph showing the change in phase shift through a section of transmission line of FIG. 4 as the states of the corrugations are changed;

FIG. 6 provides a schematic representation of a transmission line resonator;

FIG. 7 provides a schematic representation of the present invention as implemented in a folded-waveguide topology; and

FIG. 8 provides a graph showing the frequency response of the tunable resonator shown in FIG. 7.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

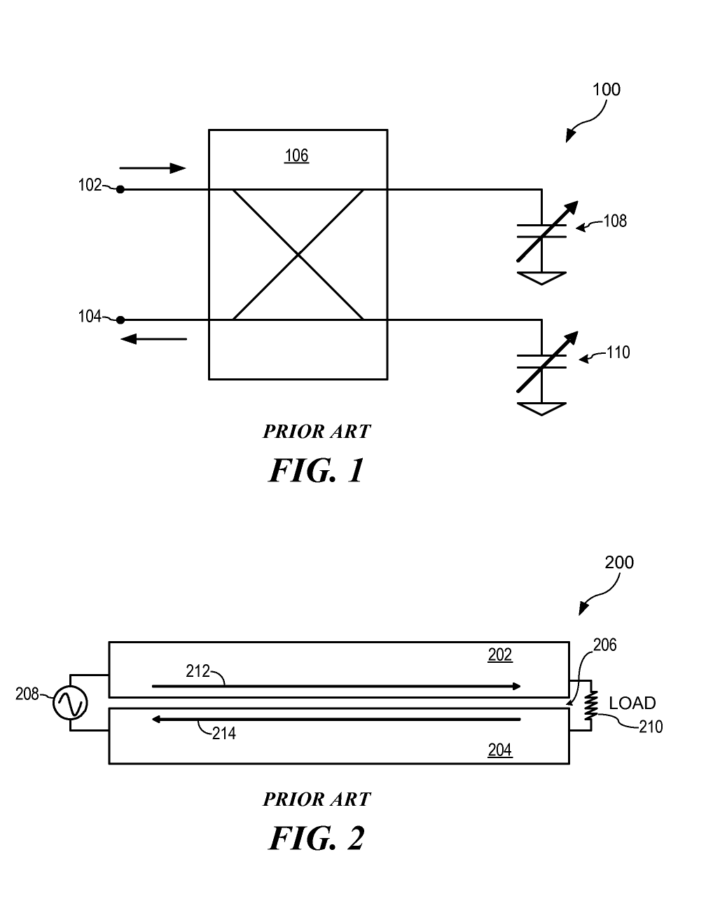

FIG. 1 illustrates a schematic representation of a prior-art reflective phase shifter 100. Reflective phase shifter 100 may have terminals 102 and 104 coupled to a hybrid power divider 106. Variable capacitors 108 and 110 may act as tunable elements.

FIG. 2 shows a schematic representation of a prior art slot-type transmission line 200, also known as a slot-line. The transmission line 200 consists of two conducting surfaces 202 and 204, separated by a non-conducting gap comprising the slot 206. A signal source 208 is illustrated as providing power to a load 210 via the conducting surfaces 202 and 204. The power is illustrated by currents 212 and 214, which are induced at the radio frequency (RF) frequency of the signal source 208. In order to satisfy the boundary conditions described by Maxwell's equations, the currents 212 and 214 will flow substantially along the edges of the conducting surfaces 202 and 204 respectively, along the slot 206. As a result, currents 212 and 214 will travel along an electrical path length of the transmission line 200 that is related to the physical length of slot 206.

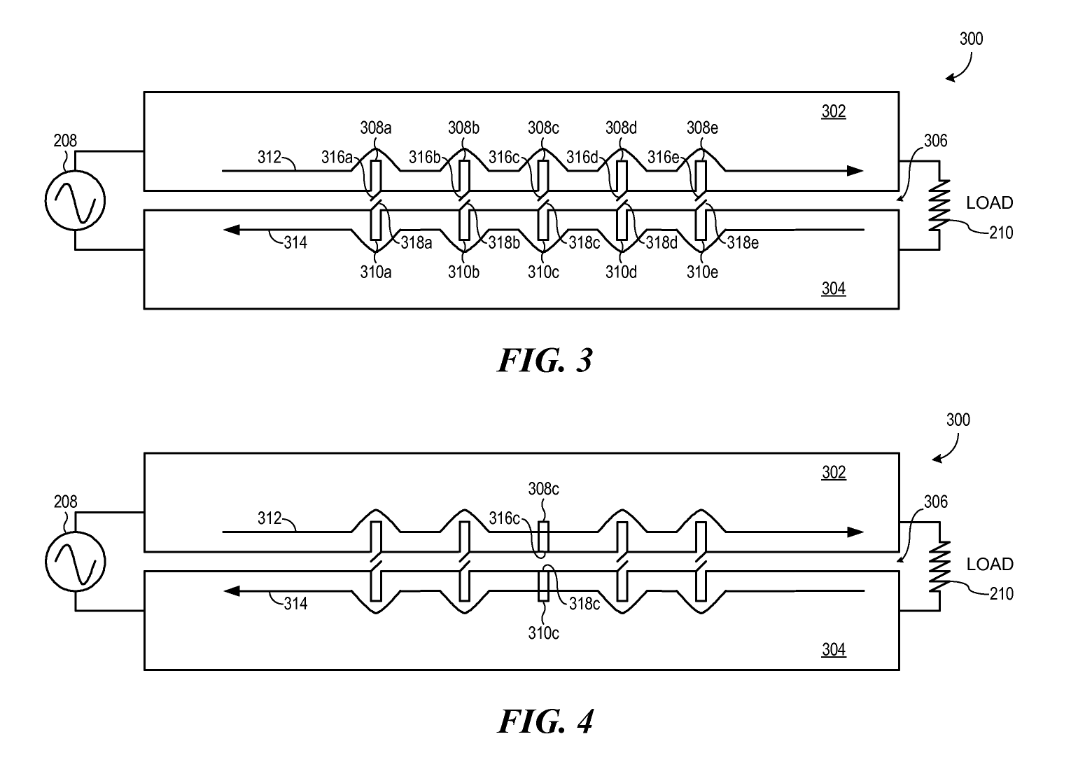

FIG. 3 illustrates a transmission line 300, comprising conductors 302 and 304, which may be separated by a slot 306. The transmission line 300 may further comprise ten perturbations, 308a through 308e and 310a through 310e, along the length of the slot 306, which may be configured to alter an electrical path length traversed by currents 312 and 314 on the transmission line 300. Thus, the transmission line 300 may comprise a corrugated slot-line. Since the currents 312 and 314 may follow the conducting edges, the effective electrical path length (as seen by the currents 312 and 314) of the transmission line 300 may be longer than the electrical path length (as seen by the currents 212 and 214) of the transmission line 200, as shown in FIG. 2, even when the physical length (distance from source 208 to load 210) is the same. Since the impedance of a transmission line is a function of its cross-sectional geometry, the impedance in the area of the slots will be different than the reference line. However, if perturbations 308a through 308e and 310a through 310e are small enough, the electrical path length may be changed while the overall effect on the impedance of transmission line 300 may remain small.

Referring to FIG. 3, the perturbations 308a through 308e and 310a through 310e may comprise secondary slots, illustrated as generally orthogonal to a primary slot 306, which is between the conductors 302 and 304. In some embodiments, the perturbations 308a through 308e and 310a through 310e may be configured to cause a change in the electrical resistance of the transmission line 300. The perturbations 308a through 308e in conductor 302 may be disposed generally opposite the slot 306 from a corresponding one of the perturbations 310a through 310e in conductor 304, forming pairs. While the illustrated embodiment comprises ten perturbations in two conductors, a greater or lesser quantity of either perturbations or conductors may be used. Further, other arrangements of perturbations could be implemented, in addition to the arrangement illustrated in FIG. 3, that allow for a relatively uniform cross section, such that the impedance remains relatively constant in substantially all areas.

The transmission line 300 further may comprise one or more switching elements 316a through 316e and 318a through 318e coupled to the conductors 302 and 304, respectively, and configured to selectively bypass a corresponding one of the perturbations 308a through 308e and 310a through 310e for tuning the transmission line 300. By placing the switching elements 316a through 316e and 318a through 318e across the slots comprising the perturbations 308a through 308e and 310a through 310e, individual perturbations 308a through 308e and 310a through 310e may be substantially removed (or shorted out) from the signal path traversed by the current 312 and/or the current 314. The switching elements 316a through 316e and 318a through 318e may comprise transistors, diodes and/or microelectromechanical systems (MEMS) switches, and may be actuated either individually or along in pairs for tuning the transmission line 300. In the illustrated embodiment of FIG. 3, the switching elements 316a through 316e and 318a through 318e may be arranged in pairs, with switching elements 316a through 316e disposed generally opposite the primary slot 306 from a corresponding one of the switching elements 318a through 318e. However, it should be understood that a different arrangement may be used, other than a pairing configuration on opposing sides of a primary slot, to selectively shorten the electrical path length.

The switching elements 316a through 316e and 318a through 318e may be configured to be reactive and/or resistive in order to selectively tune a signal. If a switching mechanism is reactive, the phase shift of the current flowing through it can be further adjusted or varied if desired as there will be a phase delay associated with the reactive element. Resistive switching elements may allow for selectively tuning the signal by selectively adjusting or varying the electrical loss of the signal over the transmission line 300.

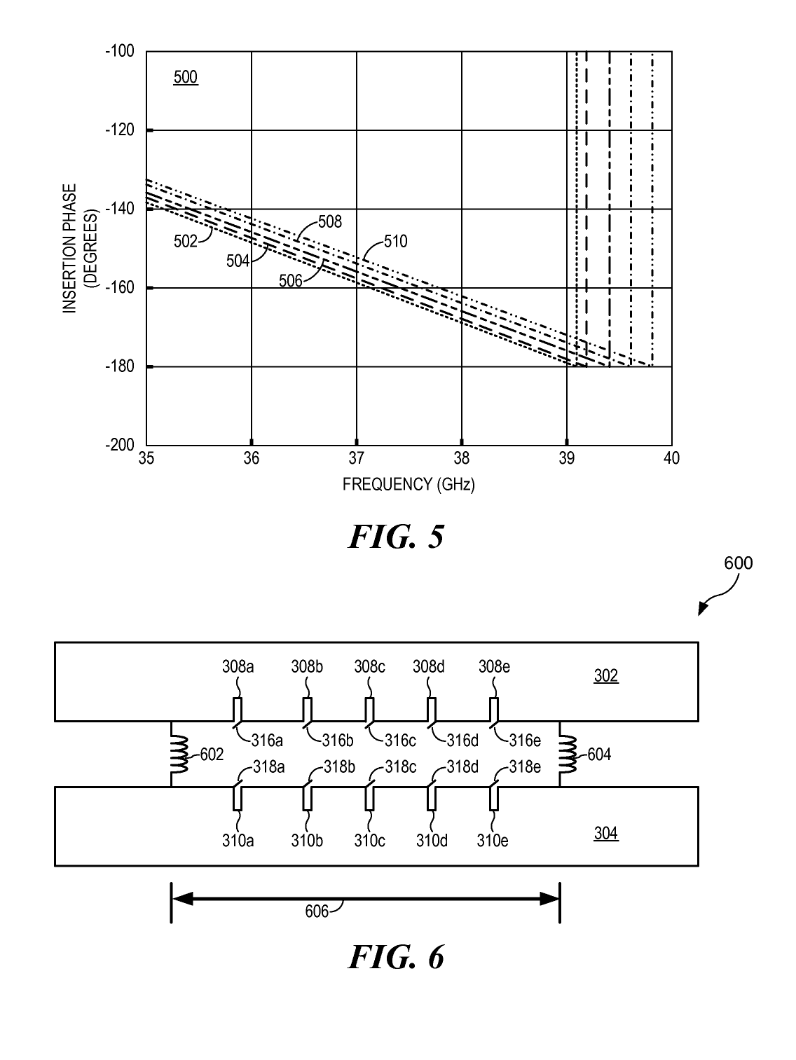

FIG. 4 illustrates that the current flow may be modified by “switching” out one of the corrugations in the transmission line 300; the overall phase shift through a line such as the transmission line 300 (as the corrugations are switched out) is shown in the graph of FIG. 5. In FIG. 4, switching elements 316c and 318c may be actuated as a pair, to short out the perturbations 308c and 310c, respectively, for tuning the transmission line 300. The electrical path length of transmission line 300 may thus be altered, allowing the currents 312 and 314 to take shorter electrical path routes than going around the slots of the perturbations 308c and 310c.

As shown in FIG. 5, Curves 502-510 of graph 500 depict the change in phase shift, as a function of frequency, through a section of an embodiment of transmission line 300 as different numbers of the perturbations 308a through 308e and 310a through 310e are bypassed. For example, the curve 502 shows the insertion phase of an embodiment of transmission line 300 if a single pair of switching elements is actuated to bypass a single pair of perturbations, as illustrated in FIG. 4. The curves 504, 506, 508 and 510 illustrate insertion phase when two, three, four and five pairs of switching elements are actuated, respectively.

Present technology provides for a number of different circuit elements that allow for the slots to be selectively switched in and out for tuning the transmission line. Some examples include transistors, p-n and metal-semiconductor junction diodes, and MEMS switches (both ohmic and capacitive-contact varieties). Each technology offers different advantages and disadvantages, depending on the final design goals and the manufacturing processes available to the designer. The present invention differs from the classic “switched-line” phase shifter where the current flow is designed to be switched drastically from state to state (along alternative transmission line sections), while in the present invention the changes in the current flow may be designed to be small and may not drastically alter the current flow along a single transmission line section.

Filters are one of the most common RF elements used in radar and communication systems. Bandpass filters in particular are used extensively to eliminate unwanted signals that are spectrally close to the signal of interest. Such filters often consist of one or more resonator elements coupled together in a way to obtain the desired passband characteristic for tuning the transmission line.

At microwave frequencies, resonator elements are often formed using “distributed” techniques, exploiting the electrical length between one or more circuit elements to obtain the desired electrical response. In the case for bandpass filters, large reflections are spaced 90° apart at the center frequency of the filter, with the constructive interference resulting in a “bandpass” response that has low loss at the center frequency and higher loss at frequencies above and below the center. Once the coupling is designed (to achieve the proper filter shape), the entire filter response can be tuned across frequency by adjusting the lengths of lines that make up the resonator elements. Since the present invention may be designed to provide a simple mechanism to alter the electrical path length of a transmission line, it may be well suited to be incorporated into a filter design to provide tunability.

FIG. 6 provides an illustrative drawing of a filter device comprising a transmission line resonator 600, which may comprise two conductors 302 and 304 coupled to two frequency-dependent resonator elements 602 and 604. The resonator elements 602 and 604 may be coupled on different ends of the transmission line resonator 600, separated by a distance 606. Generally, when two or more resonator elements are connected together, various filter shapes can be achieved by adjusting the amount of coupling from resonator to resonator. However, once the overall filter shape is achieved, the response of the filter can be tuned to different center frequencies by adjusting the electrical length (and therefore the resonant frequency) of each resonator using the current invention.

In the embodiment shown in FIG. 6, switching elements 316a through 316e coupled to the conductor 302 at perturbations 308a through 308e, respectively, and switching elements 318a through 318e coupled to the conductor 304 at perturbations 310a through 310e, respectively, may be selectively switched to bypass one or more of the perturbations 308a through 308e and 318a through 318e. The selective bypassing of the one or more perturbations 308a through 308e and 318a through 318e may allow for tuning of the electrical signal across the transmission line 300 by altering the electrical path of the signal, thereby increasing or decreasing attenuation of the signal to vary, adjust or tune electrical loss. Further, multiple transmission line resonators, such as transmission line resonator 600, may be placed end-to-end.

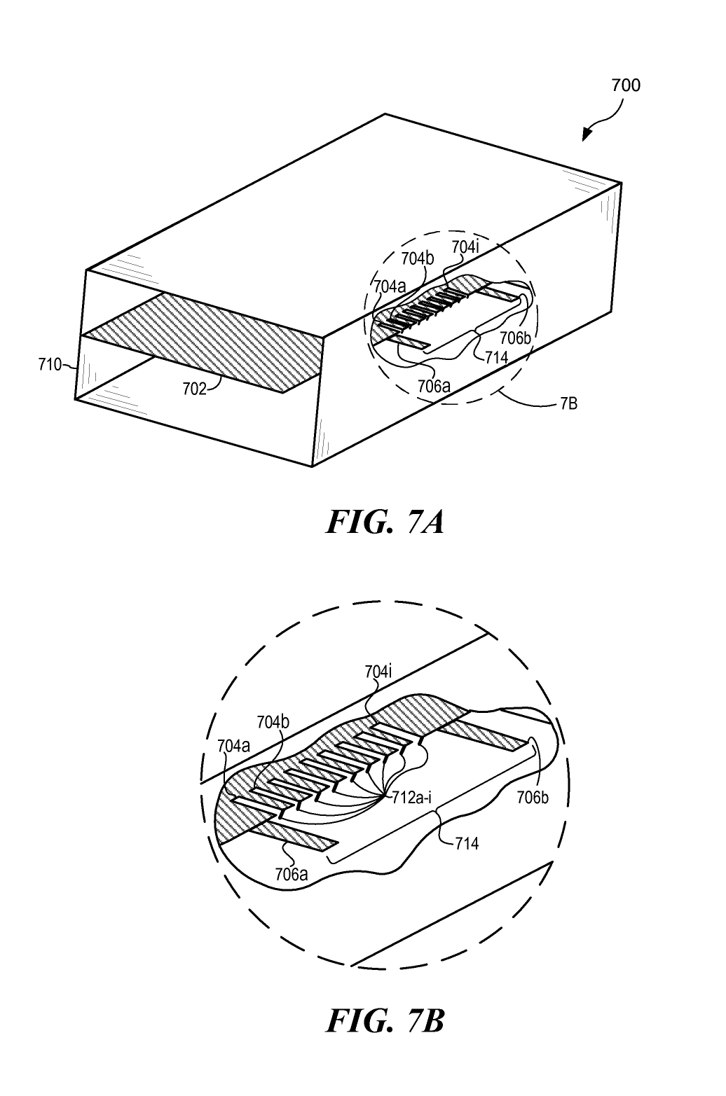

The current invention may be further applied to other filter structures that rely on transmission line elements for electrical performance. FIG. 7A illustrates a transmission line filter structure 700 that may consist of a conductor 702 embedded within a folded “H-Plane” waveguide 710, yielding a tunable filter based on waveguide technology. Conductor 702 may comprise nine perturbations 704a through 704i and two shorting posts 706a and 706b. The section of the transmission line 700 between shorting posts 706a and 706b may form a distributed resonator 714.

As shown in further detail in FIG. 7B, shorting out perturbation corrugations 704a through 704i along the transmission line 700 within the resonator 714 may alter the electrical path between shorting posts 706a and 706b. Switching elements 712a through 712i may be coupled to the conductor 702 at perturbations 704a through 704i to allow for selectively switching the elements to bypass one or more of the perturbations 704a through 704i. If the switching elements 712a through 712i are also resistive, then the signal may be attenuated by adjusting, varying or tuning the electrical loss of the signal across the transmission line. Therefore, the resonant frequency of structure 700 may be changed by switching in and out the various corrugations 704a through 704i along the line using switching elements 712a through 712i.

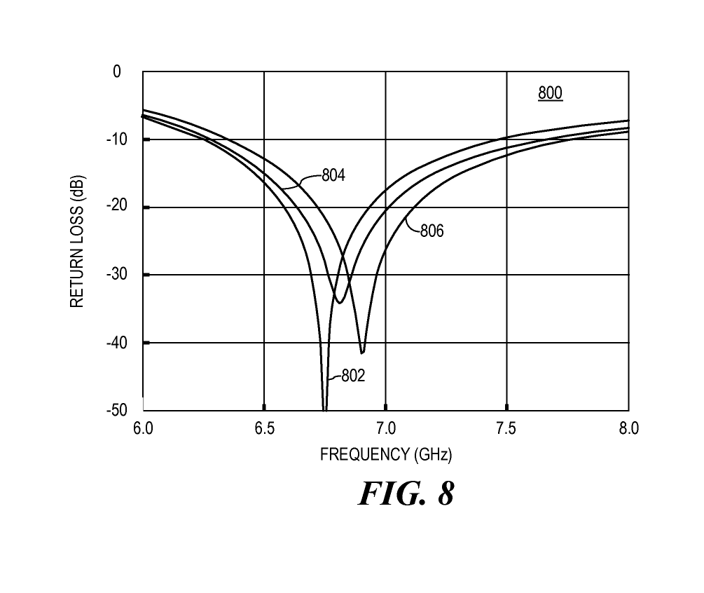

The frequency response is plotted in curves 802 through 806 of graph 800 in FIG. 8. Curves 802, 804 and 806 show the change in resonant frequency as zero, one and two of perturbations 704a through 704i are bypassed, respectively.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. An apparatus comprising:
a transmission line;
one or more perturbations along the transmission line, the perturbations configured to alter an electrical path of the transmission line; and
one or more switching elements coupled to the transmission line, the switching elements configured to selectively bypass the one or more perturbations.

2. The apparatus of claim 1 wherein the transmission line comprises a primary slot between at least two conductors.

3. The apparatus of claim 2 wherein the one or more perturbations comprise one or more secondary slots in the at least two conductors.

4. The apparatus of claim 3 wherein the secondary slots are approximately orthogonal to the primary slot.

5. The apparatus of claim 2 wherein the one or more perturbations comprise one or more pairs of perturbations, each pair of perturbations comprising a first perturbation disposed opposite the primary slot from a second perturbation.

6. The apparatus of claim 5 wherein the one or more switching elements comprise one or more pairs of switching elements, each pair of switching elements comprising a first switching element disposed opposite the primary slot from a second switching element.

7. The apparatus of claim 6 wherein the switching elements are configured to be actuated as pairs.

8. The apparatus of claim 1 wherein the switching elements are configured to be reactive.

9. The apparatus of claim 1 wherein the switching elements are configured to be resistive.

10. The apparatus of claim 1 wherein the transmission line and the one or more perturbations comprise a corrugated slotted-line.

11. The apparatus of claim 1 wherein the switching elements comprise at least one selected from the list consisting of transistors, diodes and microelectromechanical systems (MEMS) switches.

12. The apparatus of claim 1 further comprising a first frequency-dependent device coupled to a first end of the transmission line.

13. The apparatus of claim 12 further comprising a second frequency-dependent device coupled to a second end of the transmission line, the second end opposite the transmission line from first end.

14. The apparatus of claim 13 wherein the first frequency-dependent device comprises:
a second transmission line;
one or more perturbations along the second transmission line, the perturbations along the second transmission line configured to alter an electrical path length of the second transmission line; and
one or more switching elements coupled to the second transmission line, the switching elements coupled to the second transmission line configured to selectively bypass the one or more perturbations along the second transmission line.

15. The apparatus of claim 1 wherein the one or more perturbations are further configured to cause a change in an electrical loss of the transmission line.

16. A method of adjusting a signal, the method comprising:
coupling the signal onto a transmission line comprising one or more perturbations, the perturbations configured to alter an electrical path of the transmission line without altering a physical length of a conducting portion of the transmission line; and
selectively bypassing one or more of the perturbations.

17. The method of claim 16 wherein selectively bypassing one or more of the perturbations comprises selectively bypassing one or more secondary slots approximately orthogonal to a primary slot between at least two conductors.

18. The method of claim 16 wherein selectively bypassing one or more of the perturbations comprises selectively bypassing one or more pairs of perturbations.

19. The method of claim 16 wherein selectively bypassing one or more of the perturbations comprises selectively actuating at least one switching element selected from the list consisting of a reactive switching element and a resistive switching element.

20. The method of claim 16 wherein selectively bypassing one or more of the perturbations comprises selectively actuating one or more microelectromechanical system (MEMS) switches coupled to the transmission line.

21. The method of claim 16 wherein selectively bypassing one or more of the perturbations comprises selectively actuating one or more semiconductor devices coupled to the transmission line.

22. The method of claim 16 further comprising selectively attenuating the signal.

23. Means for altering characteristics of an electrical signal, the means for altering comprising:
an electrical transmission means;
one or more means for altering an electrical path of the electrical transmission means without altering a physical length of a conducting portion of the electrical transmission means; and
means for selectively bypassing the one or more means for altering an electrical path length.

24. The means of claim 23 wherein the means for selectively bypassing comprises means for shortening the electrical path.

25. The means of claim 24 wherein the means for shortening the electrical path comprises at least one selected from the list consisting of reactive means, resistive means and switching means.

26. The means of claim 23 further comprising means for selectively adjusting an electrical loss of the electrical transmission means.
